(19) United States
(12) Patent Application Publication
(10) Pub. No.: US 2016/0140617 A1
(43) Pub. Date: May 19, 2016

(54) MOBILE INFORMATION AND ADVERTISING SYSTEM AND METHOD

(71) Applicant: Mehmet Taner GIRGIN, Istanbul (TR)

(72) Inventor: Mehmet Taner GIRGIN, Istanbul (TR)

(21) Appl. No.: 14/902,339

(22) PCT Filed: Jul. 10, 2014
(86) PCT No.: PCT/TR2014/000269

§ 371 Date: Dec. 30, 2015

(30) Foreign Application Priority Data
Jul. 12, 2013 (TR) 2013/08444

(51) Int. Cl. G06Q 30/02; G06Q 20/32; G06Q 20/20

(52) U.S. Cl. CPC G06Q 30/0267; G06Q 30/0261; G06Q 30/0269; G06Q 20/202; G06Q 20/3278

(57) ABSTRACT

The present invention relates to a mobile information and advertising system (1) and method (100) which enable to convert computing devices having mobile or fixed internet (I) connection into a device which can provide information to the user according to the focus point and location of the user and demographic data about the user, without identifying the user as a person and without collecting data related to the private life of the user. The objective of the present invention; which can deliver advertisements via user devices (7) such as smart phones, computers and tablet computers, etc.; is to provide a mobile information and advertising system (1) and method (100) which can transmit user based information such as specially selected advertisements, special offers, etc. that are targeted for the user.

### FIELD OF THE INVENTION

The present invention relates to a mobile information and advertising system and method which enable to convert computing devices having mobile or fixed internet connection into a device which can provide information to the user according to the focus point and location of the user and demographic data about the user, without identifying the user as a person and without collecting data related to the private life of the user.

### BACKGROUND OF THE INVENTION

Commercial information flow to the user via internet is carried out widely via search engines and social media means.

In the commercial information flow carried out via a search engine, advertisements related to the search of the user are delivered but suitability of the displayed advertisements to the user and the quality of the advertisement content are not controlled.

The search engines in the prior art analyze the information searched by the users and provide more appropriate results to the users when the users use the search engine by logging in with their usernames. However this method does not provide rich information about an activity and/or process which is a focus point in the lives of the users, but only provides specific information regarding the entered key words. In this method, the advertisements which appear on the top positions of the searches are determined according to the prices paid by the companies. Additionally, in this type of use, behaviors of the users in using search engines are analyzed. This in turn requires the users to put privacy aside in order to obtain more meaningful results.

In the commercial information flow via social media, the servers provide information which are not required by the user at all or in order to determine the products or services that may be needed by the user, they examine in detail the information provided by the users in social media and thus the private lives of the users. This may disturb the users.

Additionally, the following patent documents are found in the state of the art related to mobile devices providing informational services:

The United States patent document no. US20130073388, an application in the state of the art, discloses a system which works via a location tracking system and which provides opportunities such as advertising, offers, sale, service. This system; which can be run via smart phones, tablet computers or regular computers; generates user behavior profile, operates based on the demographic location of the user and presents the targeted advertisement and offer to the user.

The United States patent document no. US20110225044, an application in the state of the art, discloses a system to which mobile internet advertising system is integrated. This system, which is configured to provide an advertisement suitable for the user profile, generates a digital profile of the user, updates it according to the information entered by the user, provides the opportunity of mobile purchasing to the user and can provide information to the vendor about the user profile.

The United States patent document no. US20120179527 A1, an application in the prior art, discloses a system which provides advertisement information to the mobile phones via a software. The system, which is capable of delivering the suitable advertisement to the user by using the geographic location of the user, may also provide opportunities such as making payments, shopping, etc. via the mobile device.

The Turkish patent document no. TR201106204, an application in the state of the art, discloses a method for viewing advertisements in smart phones. This method enables to deliver advertisements to users via mobile phones by using profiles and/or location information thereof.

The Turkish patent document no. TR200800895, an application in the prior art, discloses a mobile advertisement method; which determines the relevant advertisement for the messages in the mobile phones by evaluating the user profile, location of the user, user needs, content of the message, message sent time, advertisements delivered to the user previously, purchasing made by the user; and attaches an advertisement to a part of the message.

The common ground of these relatively less widespread applications is that they comprise user identification, generate user profiles and deliver advertisements to the users via these information. The advertisements that are delivered are not organized via a focus point or a field of interest of the user. Also, the activities of the user should be tracked and her/his profile should be generated and recorded centrally for the content that will be offered.

### SUMMARY OF THE INVENTION

The objective of the present invention is to provide a mobile information and advertising system and method which enable to convert computing devices having mobile or fixed internet connection into a device which can provide information to the user according to the focus point (an important stage in life, a field of interest, an important activity, etc.) of the user, the location of the user and demographic data about the user, without identifying the user as a person and without collecting data related to the private life of the user.

Another objective of the present invention is to provide a mobile information and advertising system and method which can transmit user based information such as specially selected advertisements, special offers, etc. that concern only the user.

A further objective of the present invention is to provide a mobile information and advertising system and method which can deliver advertisements via mobile devices such as smart phones and tablet computers.

Another objective of the present invention is to provide a mobile information and advertising system and method which enable delivery of information that the user may need for the focus point thereof in her/his life (wedding, having a child, etc.) rather than specific products or services as in the search engines in the state of the art.

### BRIEF DESCRIPTION OF THE DRAWINGS

FIG. 1 is the schematic view of the mobile information and advertising system.

FIG. 2 is the view of the user device and smart phone interface.

FIG. 3 is the view of the steps of the mobile information and advertising method.

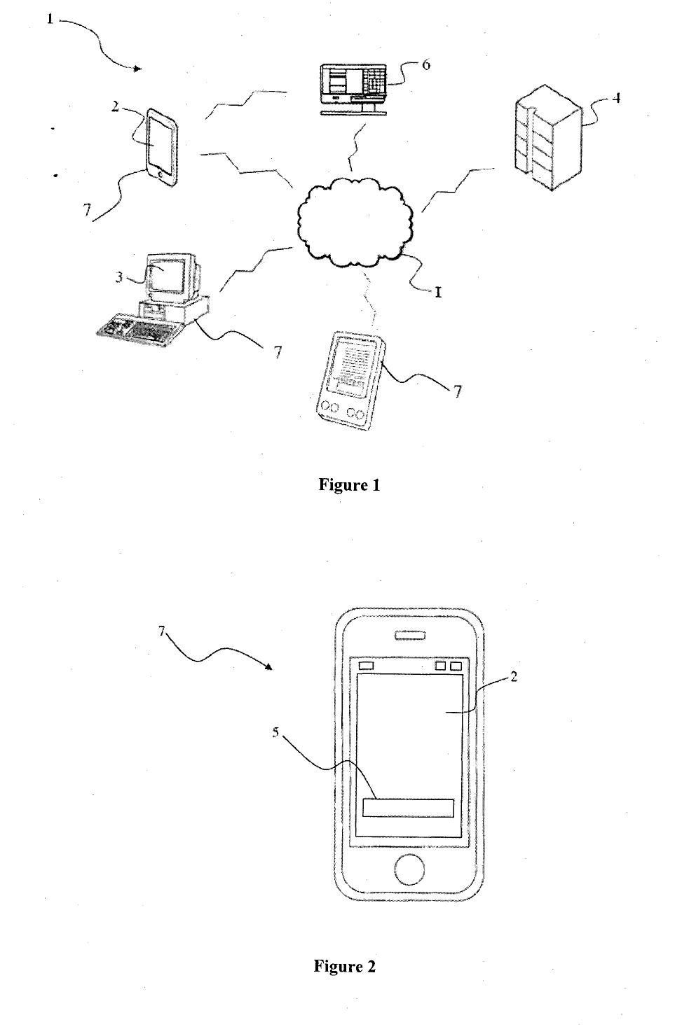

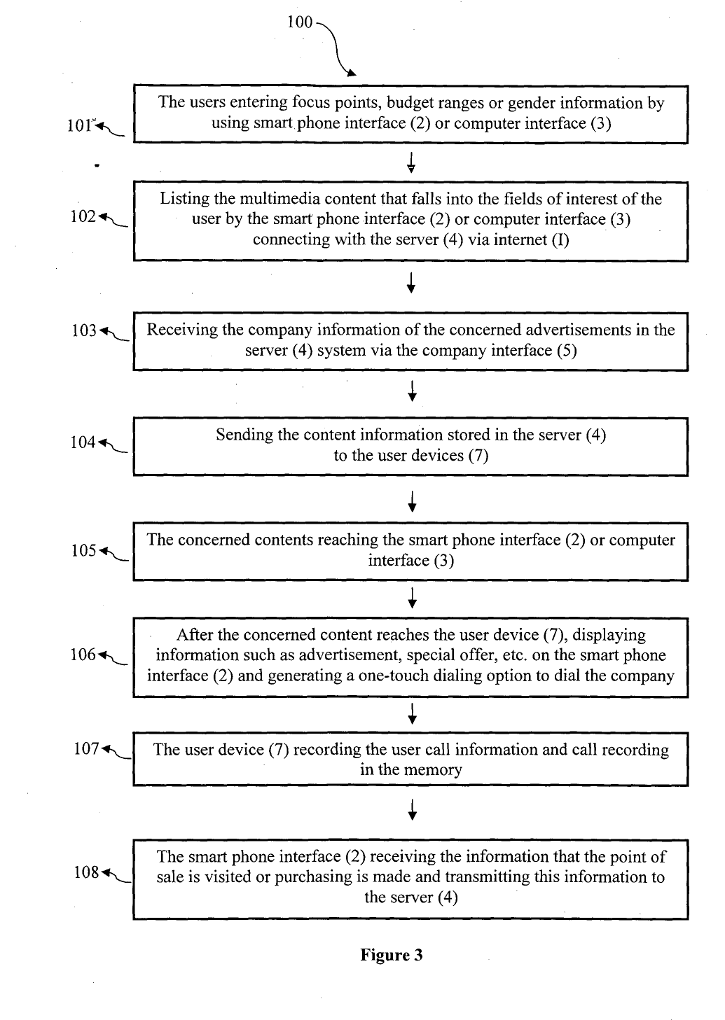

The components shown in the figures are each given reference numbers as follows:
1. Mobile information and advertising system
2. Smart phone interface
3. Computer interface
4. Server
5. Company interface
6. Pos device
7. User device
100. Mobile information and advertising method
I. Internet

### DETAILED DESCRIPTION OF THE INVENTION

A mobile information and advertising system and method developed to fulfill the objective of the present invention are illustrated in the accompanying figures.

A mobile information and advertising system (1), which enables to convert computing devices having mobile or fixed internet connection into a device which can provide information to the user according to the focus point and location of the user and demographic data about the user, basically comprises
at least one smart phone interface (2) which identifies fields of interest of the user and is able to retrieve all kinds of multimedia and commercial information according, to the fields of interest, and which can list these information without identifying the user as a person and can sort the information and advertisements by starting out only from the data on the device,
at least one computer interface (3) which identifies fields of interest of the user and can retrieve all kinds of multimedia and commercial information according to the fields of interest, and which can list these information without identifying the user as a person and can list the information and advertisements by starting out only from the data on the device,
at least one server (4) in which contents regarding commercial information of the companies are stored and which responds to the incoming queries according to the fields of interest of the users,
at least one company interface (5) which enables to input data to servers (4),
at least one pos device (6) through which the sale operation of the company and the required data communication is performed,
at least one user device (7) which enables the users to access internet (I).

In a preferred embodiment of the invention, the mobile information and advertising system (1) of the invention sends the information, which the users input to the smart phone interface (2) and/or computer interface (4), to the server (4) via internet (I), and after the required operations are performed by the server (4) data communication is again provided via internet (I). The order of the information delivered to the users is determined according to the date the information is entered to the server system (4) or by tracking the information and advertisements that the user monitored previously via a recommender system program that will be run on the user device (7). This way each user can view the content suitable to her/his field of interest at the top. However this feature that determines interests is not recorded in the server (4) system together with any user identification data and the users are not matched with individuals in the real world. User information is not required for personalization.

In another embodiment of the invention, in the mobile information and advertising system (1) of the present invention, the users can directly call the company by means of a speed dial key provided on the smart phone interface (2) and obtain any necessary information.

In another embodiment of the invention, in the mobile information and advertising system (1) of the present invention, the users can view the location of the company on a map by means of a key provided on the smart phone interface (2).

In another embodiment of the invention, in the mobile information and advertising system (1) of the present invention, the users can enter the information that they need via the smart phone interface (2) or computer interface (3) and thereby access the information, special offer and/or advertisement that they need.

In another embodiment of the invention, in the mobile information and advertising system (1) of the present invention, the users can conduct a word-based search in the content list provided to them via the smart phone interface (2) or computer interface (3).

In another embodiment of the invention, in the mobile information and advertising system (1) of the present invention, the users are not asked for any information other than gender, the city they are located, age, and budget ranges. This way, information regarding the private lives of the users is protected and user privacy is maintained.

The mobile information and advertising method (100) basically comprises the steps of
the users entering focus points, budget ranges, age and gender information by using smart phone interface (2) or computer interface (3) (101),
listing the multimedia content that falls into the fields of interest of the user by the smart phone interface (2) or computer interface (3) connecting with the server (4) via internet (1) (102),
receiving the company information of the concerned advertisements in the server (4) system via the company interface (5) (103),
sending the content information generated in the server (4) to the user devices (7) (104),
the concerned contents reaching the smart phone interface (2) or computer interface (3) (105),
after the concerned content reaches the user device (7), displaying information such as advertisement, special offer, etc. on the smart phone interface (2) and generating a one-touch dialing option to dial the company (106),
the user device (7) recording the user call information and call recording in the memory (107),
the smart phone interface (2) receiving the information that the point of sale is visited or purchasing is made, and transmitting this information to the server (4) (108).

In a preferred embodiment of the invention, in the mobile information and advertising method (100) of the present invention, the users enter their focus points, budget ranges or gender information by using the smart phone interface (2) or computer interface (3) (101). The users are not asked for any other information that can identify them in person. This way, any infringement of privacy that the users might be exposed to is prevented. The information entered by the users is transmitted to the server (4) by the user device (7) using the smart phone interface (2) or computer interface (3) via internet (1), and the server (4) lists the multimedia contents that fall into the fields of interest of the users (102). The company information pertaining to the concerned advertisements in the server (4) system is received by the company interface (5) (103) and the content information generated in the server (4) is sent to the user devices (7) (smart phones, computers, tablet computers, etc.) (104). The information sent by the server (4) reaches the smart phone interface (2) or computer interface (3) (105) and is provided for use of the user. Additionally, after the concerned content reaches the user device (7), the information such as advertisements, special oilers, etc. is displayed on the smart phone interface (2) and a one touch dialing option tom dial the company is generated (106). This way the user can reach the company that s/he desires via a single key. During all of the said processes, the user call information and call recording are recorded in the memory by the user device (7) (107), and no other device is used. This ensures that the private information or call recording of the user can only be accessed by the user herself/himself. When the user is purchasing in accordance with the information s/he receives, the smart phone interface (2) receives the information that the point of sale visited or purchasing is made, and transmits this information to the server (4) (108).

In another embodiment of the invention, in the mobile information and advertising method (100) of the present invention, communication is established between the pos device (6), which can perform sale of the company, and the smart phone interface (2) via NFC (or similar short range wireless communications protocol) and the physical communication of the user with the company and the process of sale can be controlled. Alternatively, this control can also be performed by having the user device (7) read the QR code at the point of sale or on the retail sales slip/invoice via the smart phone interface (2). Devices such as smart phones, computers, tablet computers, etc. used as the user device (7) provide internet access to the user and enables the user to perform necessary operations.

In one embodiment of the invention, in the mobile information and advertising method (100) of the present invention, all kinds of information delivered to the users are generated specific to the companies and this way quality and up-to-dateness of the content is enhanced. Furthermore, in addition to the information sent to the users, the location of the company providing the commercial information, advertisement or special offer to the users on the map is also shared within the same application.

In another embodiment of the invention, in the mobile information and advertising method (100) of the present invention, what the users need most in the activity and focus points is determined by the mobile expert system application provided in the user device and this way a personalized order is provided to the users.

In another preferred embodiment of the invention, in the mobile information and advertising method (100) of the present invention, the ratio of the content monitored in the advertisement messages taking the users to the point of sale is determined. Advertisement activity is measured by a smart POS equipment at the point of sale via NFC (or similar short range wireless communications protocol) or QR code reading and this way advertisement analyses are presented to the companies.

In another embodiment of the invention, in the mobile information and advertising method (100) of the present invention, the information asked from the users do not contain information identifying the users but only the information which determine the focus points of the users. This way, user privacy is maintained and information regarding the private lives of the users are not requested.

1. A mobile information and advertising system (1); which enables to convert computing devices having mobile or fixed internet (I) connection into a device which can provide information to the user according to the focus point and location of the user and demographic data about the user, without identifying the user as a person and without collecting data related to the private life of the user; basically comprising
at least one user device (7) which enables the users to access internet,
and characterized by
at least one smart phone interface (2) which identifies fields of interest of the user and is able to retrieve all kinds of multimedia and commercial information according to the fields of interest, and which can list these information without identifying the user as a person and can list the information and advertisements by starting out only from the data on the device,
at least one computer interface (3) which identifies fields of interest of the user and can retrieve all kinds of multimedia and commercial information according to the fields of interest, and which can list these information without identifying the user as a person and can list the information and advertisements by starting out only from the data on the device,
at least one server (4) in which contents regarding commercial information of the companies are stored and which responds to the incoming queries according to the fields of interest of the users,
at least one company interface (5) which enables to input data to servers (4),
at least one pos device (6) through which the sale operation of the company and the required data communication is performed.

2. A mobile information and advertising system (1) according to claim 1, characterized by the pos device (6) which communicates with the payment point and performs physical communication control process via NFC.

3. A mobile information and advertising system (1) according to claim 1, characterized by the smart phone interface (2) which communicates with the payment point and performs physical communication control process via QR code reading.

4. A mobile information and advertising system (1) according to claim 1, characterized by the smart phone interface (2) which does not ask the users for any information other than gender, the city they are located and budget ranges and this way ensures user privacy.

5. A mobile information and advertising system (1) according to claim 1, characterized by the smart phone interface (4) which generates all kinds of information delivered to the users specific to the companies and this way enhances quality and up-to-dateness of the content.

6. A mobile information and advertising system (1) according to claim 1, characterized by the smart phone interface (2) which, in addition to the information sent to the users, shares the location of the company providing the commercial information, advertisement or special offer to the users on the map.

7. A mobile information and advertising system (1) according to claim 1, characterized by the computer interface (3) which, in addition to the information sent to the users, shares the location of the company providing the commercial information, advertisement or special offer to the users on the map.

8. A mobile information and advertising system (1) according to claim 1, characterized by the smart phone interface (2) which enables to conduct a word-based search in the content list provided to the users.

9. A mobile information and advertising system (1) according to claim 1, characterized by the computer interface (3) which enables to conduct a word-based search in the content list provided to the users.

10. A mobile information and advertising method (100), which enables to convert computing devices having mobile or fixed internet (I) connection into a device which can provide information to the user according to the focus point and location of the user and demographic data, characterized by the steps of
the users entering focus points, budget ranges or gender information by using smart phone interface (2) or computer interface (3) (101),
listing the multimedia content that falls into the fields of interest of the user by the smart phone interface (2) or computer interface (3) connecting with the server (4) via internet (I) (102),
receiving the company information of the concerned advertisements in the server (4) system via the company interface (5) (103),
sending the content information stored in the server (4) to the user devices (7) (104),
the concerned contents reaching the smart phone interface (2) or computer interface (3) (105),
after the concerned content reaches the user device (7), displaying information such as advertisement, special offer, etc. on the smart phone interface (2) and generating a one-touch dialing option to dial the company (106),
the user device (7) recording the user call information and call recording in the memory (107),
the smart phone interface (2) receiving the information that the point of sale is visited or purchasing is made, and transmitting this information to the server (4) (108).

11. A mobile information and advertising method (100) according to claim 10, characterized in that, in the step of the smart phone interface (2) receiving the information that the point of sale is visited or purchasing is made, and transmitting this information to the server (4) (108), the information that the point of sale is visited or purchasing is made is received by the smart phone interface (2) from the pos device (6) via NFC method.

12. A mobile information and advertising method (100) according to claim 10, characterized in that, in the step of the smart phone interface (2) receiving the information that the point of sale is visited or purchasing is made, and transmitting this information to the server (4) (108), the information that the point of sale is visited or purchasing is made is received by the smart phone interface (2) via QR code reading method.
